(19) United States
(12) Patent Application Publication
(10) Pub. No.: US 2022/0052976 A1
(43) Pub. Date: Feb. 17, 2022

(54) ANSWER TEXT PROCESSING METHODS AND APPARATUSES, AND KEY TEXT DETERMINATION METHODS

(71) Applicant: ALIPAY (HANGZHOU) INFORMATION TECHNOLOGY CO., LTD., Hangzhou (CN)

(72) Inventors: Shuang Peng, Hangzhou (CN); Ze Zhan, Hangzhou (CN); Hengbin Cui, Hangzhou (CN); Yangyi Xie, Hangzhou (CN); Weifeng Lou, Hangzhou (CN)

(73) Assignee: ALIPAY (HANGZHOU) INFORMATION TECHNOLOGY CO., LTD., Hangzhou (CN)

(21) Appl. No.: 17/357,933

(22) Filed: Jun. 24, 2021

(30) Foreign Application Priority Data
Aug. 14, 2020 (CN) 202010818292.5

(51) Int. Cl. H04L 12/58; G06F 16/31; G06F 16/332

(52) U.S. Cl. CPC H04L 51/18; H04L 51/02; G06F 16/3326; G06F 16/3329; G06F 16/313

(57) ABSTRACT

The present specification provides answer text processing methods and apparatuses and key text determination methods. In some embodiments, based on the previously described data processing methods, a piece of answer text that corresponds to a target question is determined from a predetermined knowledge base as a piece of target answer text at first; then one or more key texts that are closely associated with the target question and corresponds to a relatively high user attention measure is recognized and determined from the piece of target answer text, and the previously described key text in the piece of target answer text is labeled; and furthermore, the previously described key text can be identified in the piece of target answer text displayed to a user. Therefore, the user can read relatively valuable key information that the user needs in the piece of target answer text conveniently and efficiently.

### CROSS-REFERENCE OT RELATED APPLICATIONS

This application claims priority to Chinese Patent Application No. 202010818292.5, filed on Aug. 14, 2020, which is hereby incorporated by reference in its entirety.

### TECHNICAL FIELD

The present specification belongs to the technical field of Internet, and in particular, to answer text processing methods and apparatuses, and key text determination methods.

### BACKGROUND

When customer service reply is performed, appropriate pieces of answer texts can usually be retrieved by customer service robots from predetermined knowledge bases to reply to users. However, answer texts directly retrieved by customer service robots from predetermined knowledge bases can sometimes have relatively long text content. For example, a piece of answer text retrieved and returned to a user by a customer service robot may be a lengthy piece that includes hundreds of text characters. As such, the user needs to read the previously described long piece of text content carefully to identify valuable key information that the user needs eventually, which results in relatively poor user experiences.

### SUMMARY

The present specification provides answer text processing methods and apparatuses, and key text determination methods, to enable users to read relatively valuable key information that the users need from target answer texts conveniently and efficiently, and improve user experiences.

The answer text processing methods and apparatuses, and key text determination methods provided in the present specification are implemented as follows.

An answer text processing method is provided, including: a target question is determined; a piece of answer text that corresponds to the target question is determined from a predetermined knowledge base as a piece of target answer text, where the predetermined knowledge base stores multiple pieces of answer text; one or more key texts in the piece of target answer text are determined, where the key text is text data in the piece of target answer text that is associated with the target question and that has an attention measure that is greater than a predetermined threshold; the key text in the piece of target answer text is labeled to obtain a piece of labeled target answer text; and the piece of labeled target answer text is fed back to an end-user device, where the end-user device is configured to display the piece of target answer text to a user and identify the one or more key texts in the piece of displayed target answer text in a predetermined identification way.

An answer text processing method is provided, including: a question asked by a user is received, and a reply processing request is generated in response to the question, where the reply processing request includes the question asked by the user; the reply processing request is sent to a server, where the server is used to determine a piece of target answer text for answering the question asked by the user, and one or more key texts in the piece of target answer text, and label the one or more key texts in the piece of target answer text to obtain a piece of labeled target answer text, the key text is text data in the piece of target answer text that is associated with the target question and that has an attention measure greater than a predetermined threshold; the piece of labeled target answer text is received; and the piece of target answer text is displayed to the user, and the one or more key texts in the piece of displayed target answer text are identified in a predetermined identification way.

A key text determination method is provided, including: a piece of target answer text and a target question corresponding to the piece of target answer text are obtained; and a predetermined machine reading model is called to perform data processing based on the target question and the piece of target answer text, to recognize one or more key texts from the piece of target answer text, where the key text is text data in the piece of target answer text that is associated with the target question and corresponds to an attention measure greater than a predetermined threshold.

An answer text processing apparatus is provided, including: a first determination module, configured to determine a target question; a second determination module, configured to determine a piece of answer text that corresponds to the target question from a predetermined knowledge base as a piece of target answer text, where the predetermined knowledge base stores multiple pieces of answer texts; a third determination module, configured to determine one or more key texts in the target answer text, where the key text is text data in the piece of target answer text that is associated with the target question and corresponds to an attention measure greater than a predetermined threshold; and a labeling module, configured to label the one or more key texts in the piece of target answer text to obtain a piece of labeled target answer text.

An answer text processing apparatus is provided, including: a first receiving module, configured to receive a question asked by a user and generate a reply processing request in response to the question, where the reply processing request includes the question asked by the user; a sending module, configured to send the reply processing request to a server, where the server is used to determine a piece of target answer text for answering the question asked by the user and one or more key texts in the piece of target answer text, and label the key text in the target answer text to obtain a piece of labeled target answer text, and the key text is text data in the piece of target answer text that is associated with a target question and corresponds to an attention measure greater than a predetermined threshold; a second receiving module, configured to receive the piece of labeled target answer text; and a display module, configured to display the piece of target answer text to the user and identify the one or more key texts in the piece of displayed target answer text in a predetermined identification way.

A server is provided, including a processor and a memory configured to store an instruction executable by the processor, where the processor executes the instruction to implement the following: determining a target question; determining a piece of answer text that corresponds to the target question from a predetermined knowledge base as a piece of target answer text, where the predetermined knowledge base stores multiple pieces of answer texts; determining one or more key texts in the piece of target answer text, where the key text is text data in the piece of target answer text that is associated with the target question and corresponds to an attention measure greater than a predetermined threshold; and labeling the key text in the piece of target answer text to obtain a piece of labeled target answer text.

A computer-readable storage medium is provided, where a computer instruction is stored on the computer-readable storage medium, and the following is implemented when the instruction is executed: determining a target question; determining a piece of answer text that corresponds to the target question from a predetermined knowledge base as a piece of target answer text, where the predetermined knowledge base stores multiple pieces of answer texts; determining one or more key texts in the piece of target answer text, where the key text is text data in the piece of target answer text that is associated with the target question and corresponds to an attention measure greater than a predetermined threshold; and labeling the one or more key texts in the piece of target answer text to obtain a piece of labeled target answer text.

According to the answer text processing methods and apparatuses, and key text determination methods provided in the present specification, a piece of answer text that corresponds to a target question is determined from a predetermined knowledge base as a piece of target answer text at first; then one or more key texts that are closely associated with the target question and that each have a relatively high user attention measure are automatically recognized and determined from the piece of target answer text, and the aforementioned key texts in the piece of target answer text are labeled; and further, the aforementioned key texts can be identified in the piece of target answer text displayed to a user. Therefore, the user can read relatively valuable key information that the user needs in the piece of target answer text conveniently and efficiently without wasting energy and time to read all content in the piece of target answer text, and user experiences are improved.

### BRIEF DESCRIPTION OF DRAWINGS

To describe embodiments in the present specification more clearly, the following briefly introduces the accompanying drawings needed in the embodiments. The accompanying drawings in the following description merely show some embodiments in the present specification, and a person of ordinary skill in the art can still derive other drawings from these accompanying drawings without making innovative efforts.

FIG. 1 is a schematic diagram illustrating an embodiment of a system using an answer text processing method, according to some embodiments of the present specification;

FIG. 2 is a schematic diagram illustrating an embodiment of using an answer text processing method in a scenario example, according to some embodiments of the present specification;

FIG. 3 is a schematic diagram illustrating an embodiment of using an answer text processing method in a scenario example, according to some embodiments of the present specification;

FIG. 4 is a schematic diagram illustrating an embodiment of using an answer text processing method in a scenario example, according to some embodiments of the present specification;

FIG. 5 is a schematic flowchart illustrating an answer text processing method, according to some embodiments of the present specification;

FIG. 6 is a schematic diagram illustrating an embodiment of an answer text processing method, according to some embodiments of the present specification;

FIG. 7 is a schematic flowchart illustrating an answer text processing method, according to some embodiments of the present specification;

FIG. 8 is a schematic flowchart illustrating a key text determination method, according to some embodiments of the present specification;

FIG. 9 is a schematic structural composition diagram illustrating a server, according to some embodiments of the present specification; and

FIG. 10 is a schematic structural composition diagram illustrating an answer text processing apparatus, according to some embodiments of the present specification.

### DESCRIPTION OF EMBODIMENTS

To make a person skilled in the art better understand the technical solutions in the present specification, the following describes in detail the technical solutions in the embodiments of the present specification with reference to the accompanying drawings in the embodiments of the present specification. Clearly, the described embodiments are merely some but not all of the embodiments of the present specification. All other embodiments obtained by a person of ordinary skill in the art based on the embodiments of the present specification without innovative efforts shall fall within the protection scope of the present specification.

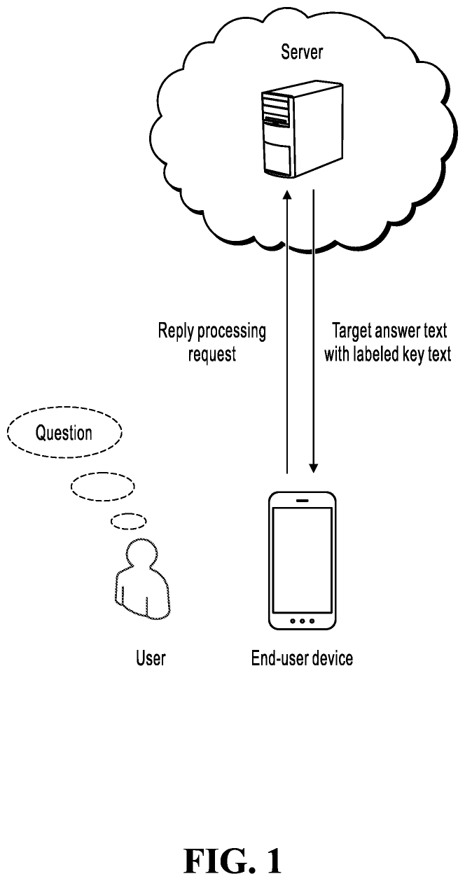

The embodiments of the present specification provide an answer text processing method. The method can specifically be applied to a system including a server and an end-user device. References can be specifically made to FIG. 1. The previously described server and end-user device can be connected in a wired or wireless way for specific data interaction.

During specific implementation, a user can ask a question through the end-user device.

The end-user device can receive the question asked by the user, generate a reply processing request in response to the question, the reply processing request including the question asked by the user, and send the previously described reply processing request to the server.

The server can obtain the question asked by the user based on the received reply processing request and determine a predetermined question matched with the question asked by the user from multiple predetermined questions as a target question. The server can determine a piece of answer text that corresponds to the target question from a predetermined knowledge base as a piece of target answer text, where the predetermined knowledge base stores multiple pieces of answer text. Further, the server can determine one or more key texts in the piece of target answer text, the key text is text data in the target answer text that is associated with the target question and corresponds to an attention measure greater than a predetermined threshold, and label the one or more key texts in the piece of target answer text to obtain a piece of labeled target answer text, i.e., a piece of target answer text with the one or more labeled key texts. The server can send the previously described piece of labeled target answer text to the end-user device.

The end-user device receives the previously described piece of labeled target answer text. The end-user device can display the corresponding piece of target answer text to the user, and identify, in the piece of displayed target answer text, the one or more key texts in the piece of target answer text in a predetermined identification way. As such, the user can directly read relatively valuable key information corresponding to a relatively high user attention measure in the piece of target answer text conveniently and efficiently without wasting energy and time to read all content in the piece of target answer text, user operations are simplified, and user experiences are improved.

In the present embodiments, the server can specifically include a back-end server applied to a network platform side and capable of realizing functions such as data transmission and data processing. Specifically, the server can be, for example, an electronic device with a data operation and storage function and a network interaction function. Or, the server can also be a software program running in the electronic device to support data processing, data storage, and network interaction. The number of servers that the server refers to is not specifically limited in the present embodiments. The server can specifically be one server, or can be several servers or a server cluster including a plurality of servers.

In the present embodiments, the end-user device can specifically include a front-end device applied to a user side and capable of realizing functions such as data collection and data transmission. Specifically, the end-user device can be, for example, a desktop computer, a pad, a laptop, a smart phone, and an intelligent wearable device. Or, the end-user device can also be a software application (APP) capable of running in the previously described electronic device. For example, the end-user device can be a certain APP or a chat group running in a mobile phone.

In a specific scenario example, references can be made to FIG. 1, a question asked by a user can be automatically answered by the answer text processing method provided in the embodiments of the present specification.

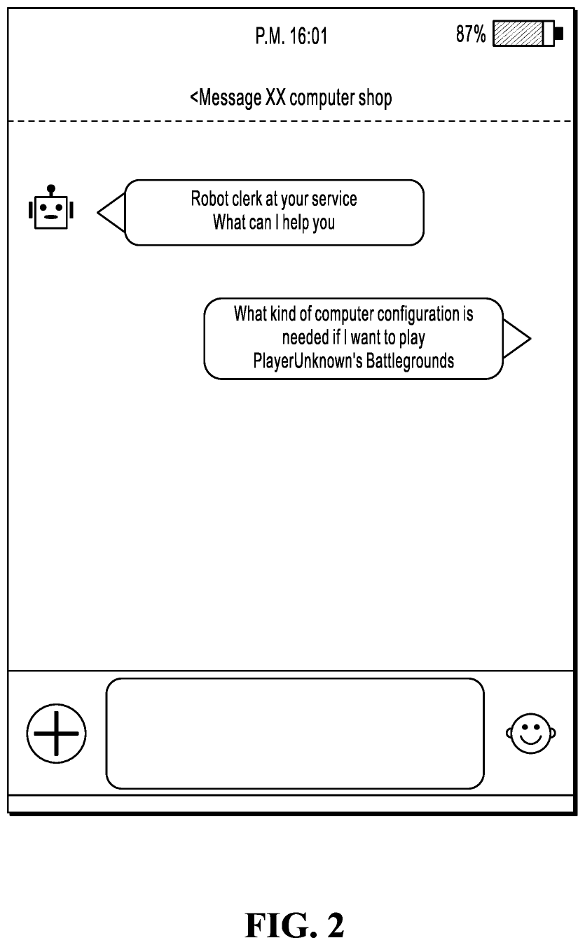

In the present scenario example, for example, references can be made to FIG. 2, the user can ask a question “what kind of computer configuration is needed if I want to play PlayerUnknown's Battlegrounds” in a dialog box with a customer service robot (for example, a robot clerk) of a certain computer shop by using a mobile phone as an end-user device. The mobile phone collects the question (which can be recorded as an initial question) asked by the user, generates a corresponding reply processing request including the initial question, and sends the previously described reply processing request to a cloud server responsible for customer service robot service.

The cloud server receives the previously described reply processing request, and obtains the initial question asked by the user by data parsing. The cloud server can perform semantic matching in multiple predetermined questions based on the previously described initial question, to identify a predetermined question “what kind of configuration is needed by PlayerUnknown's Battlegrounds” matched with the initial question as a target question.

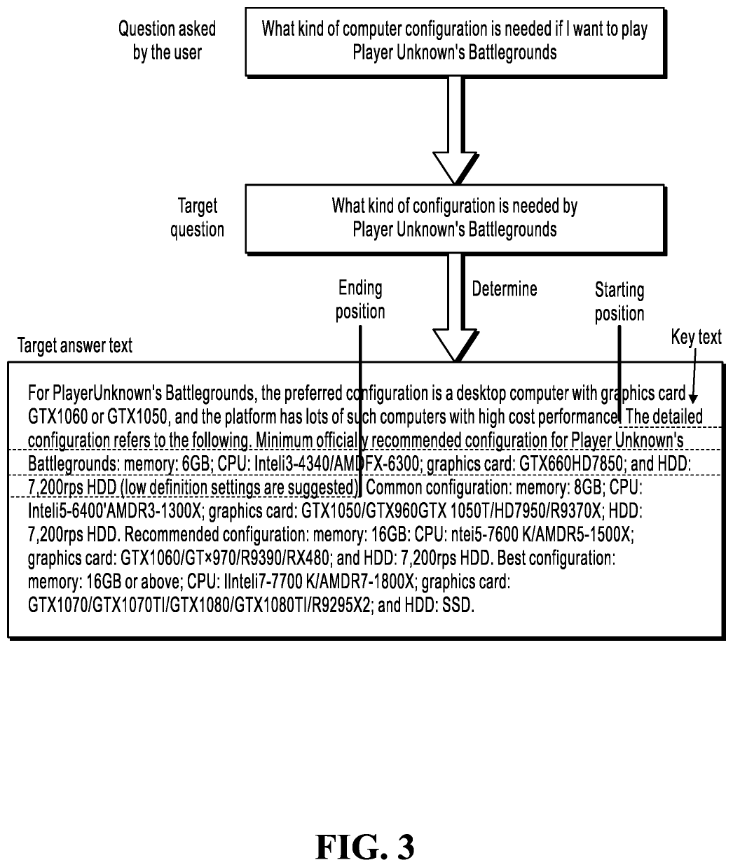

Further, the cloud server can retrieve a predetermined knowledge base based on the previously described target question, where the predetermined knowledge base stores a piece of pre-prepared answer text corresponding to each predetermined question. The cloud server can identify a piece of answer text that corresponds to the target question and including relatively long content from the predetermined knowledge base as a piece of target answer text. References can be made to FIG. 3.

Further, the cloud server can call a predetermined machine reading model to process, by taking the previously described piece of target answer text and target question as a model input to recognize and determine a part of text data in the piece of original answer text including the relatively long content as a key text.

The previously described key text can specifically be understood as a part of text data in the piece of target answer text that is closely associated with the target question, corresponds to relatively high attention measures for most users, and has a relatively high possibility of including information that the user needs. For example, the previously described key text can be a part of text data that is copied by customer service agents at a relatively high frequency from the piece of target answer text for feedback to users when the same or similar questions as the target question are answered.

The previously described predetermined machine reading model can specifically include a pre-trained data processing model, capable of recognizing and determining key texts from pieces of answer text based on the pieces of answer text and corresponding questions.

Based on the previously described method, the cloud server can determine the key text in the previously described piece of target answer text, label a starting position and an ending position of the previously described key text in the piece of target answer text as a piece of labeled target answer text, and send the previously described piece of labeled target answer text to the end-user device.

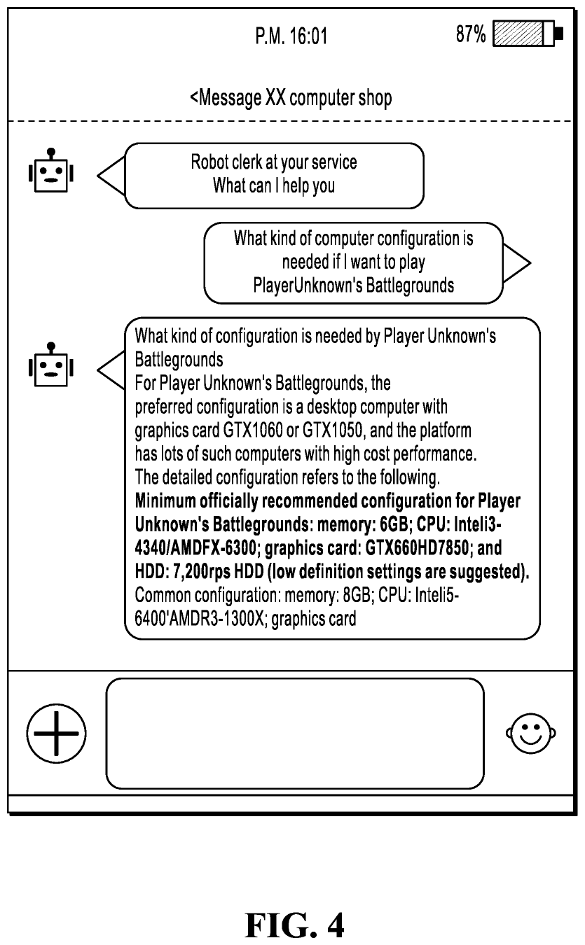

After receiving the previously described piece of labeled target answer text, references can be made to FIG. 4. The end-user device can display the piece of target answer text in the dialog box and identify a key text “officially recommended configuration for PlayerUnknown's Battlegrounds: 7,200 rps hard disk drive (HDD) (low definition settings are suggested)” in the piece of target answer text in a highlighting way (or another identification way that another text content in the piece of target answer text can be distinguished) to answer the question asked by the user.

As such, the user can read relatively valuable key information that the user needs in the piece of target answer text conveniently and efficiently without wasting energy and time to read the whole piece of target answer text, and user experiences are improved.

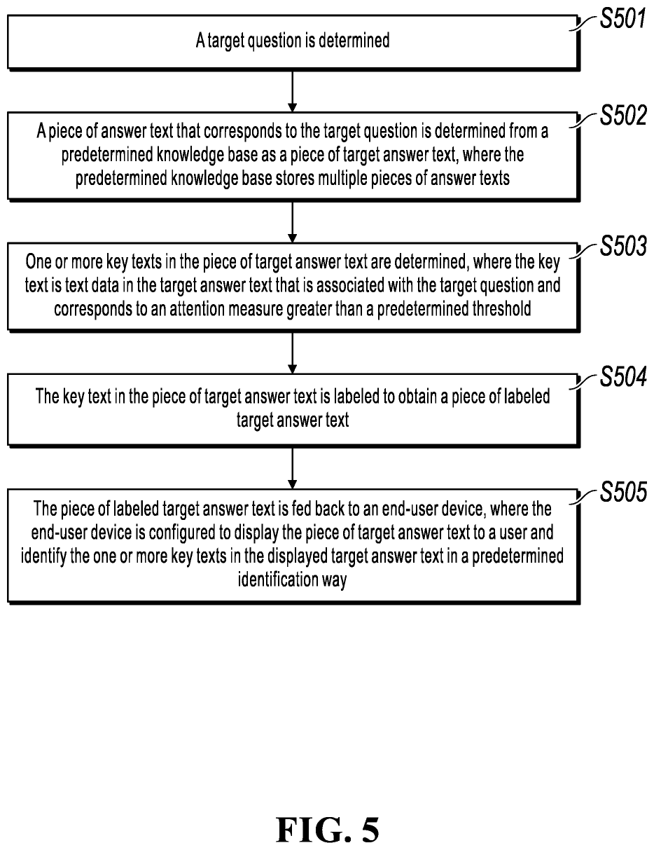

The embodiments of the present specification provide an answer text processing method. References can be made to FIG. 5. During specific implementation, the method can include the following steps.

S501. A target question is determined.

In one or more embodiments, the previously described target question can specifically be a question (which can be recorded as an initial question) asked by a user, or the same or similar predetermined question (for example, a standard question) that is matched based on the question asked by the user.

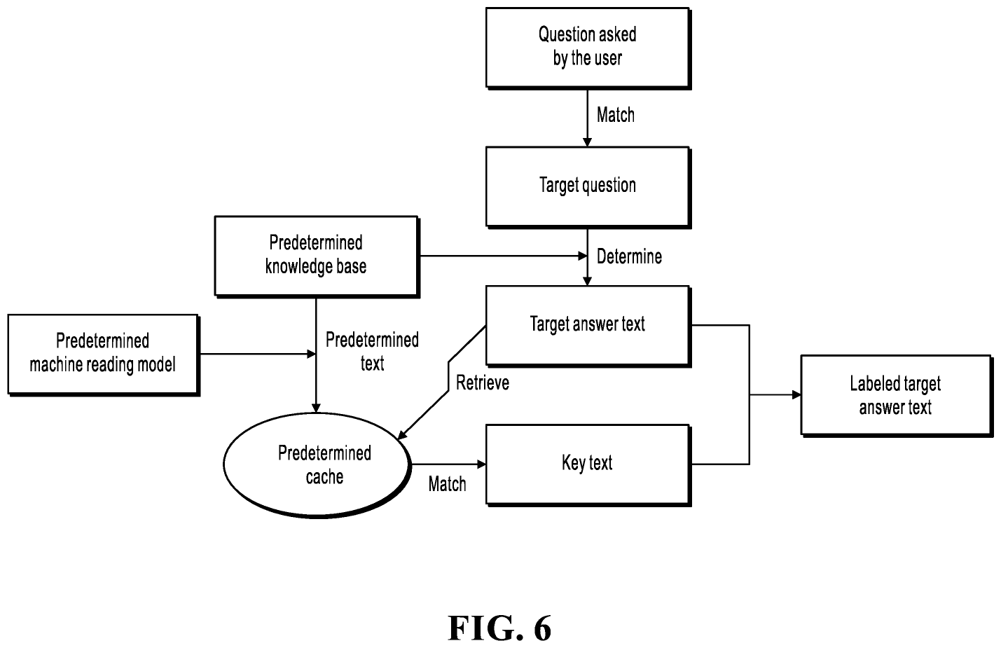

In one or more embodiments, references can be made to FIG. 6, during specific implementation, the previously described operation that a target question is determined can include the following content: a question asked by a user is obtained; and a matched predetermined question is determined from multiple predetermined questions as the target question based on the question asked by the user.

In one or more embodiments, during specific implementation, the user can ask a question expected to be answered through an end-user device. Correspondingly, the end-user device can receive the question asked by the user and generate a corresponding reply processing request in response to the question, where the previously described reply processing request can include the question asked by the user. The end-user device sends the previously described reply processing request including the question asked by the user to a server in a wired or wireless way. The server receives the reply processing request and parses the reply processing request to obtain the question asked by the user.

In one or more embodiments, during specific implementation, the server can identify the predetermined question that is semantically the same as or similar to the question asked by the user from the predetermined questions as the target question by semantic matching, etc.

Specifically, for example, when customer service reply is performed, the user can enter a question “what is the delivery cost for a desktop computer” in a dialog box with a customer service robot through a mobile phone. The customer service robot can collect the question asked by the user as an initial question through the mobile phone, generate a reply processing request including the initial question, and then send the reply processing request to the cloud server responsible for the customer service. After receiving the reply processing request, the cloud server can obtain the initial question by parsing at first, and then identify a predetermined question that is semantically the same as or similar to the initial question from multiple predetermined questions as a target question based on semantic matching. For example, the cloud server identifies a predetermined question “what is the typical cost of delivery for a desktop computer” from the multiple predetermined questions as the target question that is matched with the initial question asked by the user.

S502. A piece of answer text that corresponds to the target question is determined from a predetermined knowledge base as a piece of target answer text, where the predetermined knowledge base stores multiple pieces of answer text.

In one or more embodiments, the previously described predetermined knowledge base can store multiple pieces of answer text, where each piece of answer text in the previously described multiple pieces of answer text corresponds to a predetermined question, and is used to answer the corresponding predetermined question.

In one or more embodiments, during specific implementation, references can be made to FIG. 6, the predetermined knowledge base can be retrieved based on the target question to identify the piece of answer text that corresponds to the target question from the multiple pieces of answer text stored in the predetermined knowledge base as the piece of target answer text.

In one or more embodiments, the previously described predetermined knowledge base can be updated based on a specific condition. For example, when there is a new predetermined question, a new piece of answer text can be generated for the new predetermined question, and the piece of answer text can be stored in the predetermined knowledge base to update the predetermined knowledge base. For another example, when an answer to an existing predetermined question changes, a piece of existing answer text that is stored in the predetermined knowledge base and corresponds to the predetermined question can be modified to update the predetermined knowledge base.

S503. One or more key texts in the piece of target answer text are determined, where the key text is text data in the piece of target answer text that is associated with the target question and corresponds to an attention measure greater than a predetermined threshold.

In one or more embodiments, the previously described key text can specifically be understood as a part of text data in the piece of target answer text that is closely associated with the target question, corresponds to relatively high attention measure measures (for example, the attention measures are greater than the predetermined threshold) for most users, and has a relatively high possibility of including information that the user needs. The previously described predetermined threshold can be an average user attention measure. For example, the previously described key text can be a part of text data that is copied by customer service agents at a relatively high frequency from the piece of target answer text for feedback to users when the same or similar questions as the target question are answered.

In one or more embodiments, the piece of target answer text may have long text content sometimes. For example, the piece of corresponding target answer text is a whole piece of text content that includes hundreds of characters and records delivery cost calculation rules for different types of computers under different conditions. However, for most users, only a sentence “the delivery cost for one trip of a desktop computer is about 100” in the previously described piece of answer text is valuable information that the users really need, i.e., the key text in the piece of target answer text.

In one or more embodiments, during specific implementation, the operation that one or more key texts in the piece of target answer text are determined can include the following content: a predetermined machine reading model is called to perform data processing based on the target question and the piece of target answer text to recognize the one or more key texts from the piece of target answer text.

In one or more embodiments, the previously described predetermined machine reading model can specifically be understood as a pre-trained data processing model capable of recognizing and determining key texts from pieces of answer text based on the pieces of answer text and corresponding questions.

In one or more embodiments, during specific implementation, the piece of target answer text and the target question can be input to the predetermined machine reading model as a model input, the predetermined machine reading model is run to obtain a corresponding model output, and the key text in the piece of target answer text can be determined based on the previously described model output.

In one or more embodiments, the previously described predetermined machine reading model can specifically include a bidirectional encoder representations from transformers (BERT)-based model, or can include a bi-directional attention measure flow (BiDAF)-based model, or can further include an embedding from language models (ELMo)-based model, etc. Of course, it is worthwhile to note that the predetermined machine reading models listed above are merely illustrative descriptions. During specific implementation, other types of models can further be used to construct the previously described predetermined machine reading model based on specific applications and processing needs, which are not limited in the present specification.

In one or more embodiments, the previously described predetermined machine reading model can specifically be constructed based on the following method.

S1. A historical customer service reply record is obtained.

S2. A question-answer text pair is extracted from the historical customer service reply record, where the question-answer text pair includes a question text asked by a user and a piece of reply text returned by a customer service agent, and the piece of reply text includes a part of text data extracted by the customer service agent for use from a piece of answer text.

S3. The piece of answer text and predetermined question corresponding to the question-answer text pair are determined based on the predetermined knowledge base.

S4. Training data is constructed based on the question-answer text pair and the piece of answer text and predetermined question corresponding to the question-answer text pair, where each set of training data in the training data at least includes a predetermined question, a piece of reply text, and a piece of answer text.

S5. Model training is performed by using the training data to obtain the predetermined machine reading model.

In one or more embodiments, the previously described historical customer service reply record can specifically include a historical interaction record between the user and the customer service agent, where the interaction record can specifically include multiple question-answer text pairs between the user and the customer service agent.

In one or more embodiments, each question-answer text pair can specifically include a question text that the user asks the customer service agent and a piece of reply text returned by the customer service agent for the question text asked by the user. Generally, the customer service agent (for example, a clerk) may identify a piece of answer text that corresponds to a question asked by a user from the predetermined knowledge base based on the question at first, and then only extract a part of text data that the user is interested in and pays more attention to in the previously described piece of answer text for feedback to the user based on customer service experiences and a specific condition.

For example, for a question text “what is the delivery cost for a desktop computer” asked by the user, the customer service agent may usually not copy and feed back a whole piece of target answer text stored in the predetermined knowledge base to the user directly, instead, may copy a part of text content that the user may pay more attention to at a high possibility in the previously described piece of target answer text for feedback to the user as a reply text based on customer service experiences of the customer service agent and focuses of attentions of most users.

In one or more embodiments, during specific implementation, multiple different question-answer text pairs can be extracted from the historical customer service reply record. Further, each question-answer text pair can be processed based on the predetermined knowledge base to identify a piece of answer text and predetermined question corresponding to each question-answer text pair.

Specifically, taking processing a question-answer text pair as an example, the predetermined knowledge base can be retrieved at first, to identify a source of a piece of reply text in the question-answer text pair from the multiple pieces of stored answer text as a piece of answer text corresponding to the question-answer text pair, and a predetermined question corresponding to the question-answer text pair is determined as a predetermined question that corresponds to a question text in the question-answer text pair. The same process can be performed on the other question-answer text pairs based on the previously described method to determine the piece of answer text and predetermined question corresponding to each question-answer text pair respectively.

In one or more embodiments, during specific implementation, multiple sets of training data can be constructed based on the previously described question-answer text pairs and the determined answer text and predetermined questions corresponding to the question-answer text pairs. The previously described training data can specifically be a tuple, and each set of training data can at least include three types of data, i.e., a predetermined question, a piece of reply text, and a piece of answer text.

In one or more embodiments, during specific implementation, the previously described operation that training data is constructed based on the question-answer text pair and the piece of answer text and predetermined question corresponding to the question-answer text pair can include: question-answer text pairs are divided into multiple data sets, where reply text in the question-answer text pairs in the same data set comes from the same piece of answer text; a using frequency of each piece of reply text in each data set is counted; and the piece of reply text with the highest using frequency in each data set and a predetermined question and answer text corresponding to the question-answer text pairs in the data set are obtained as training data.

When being specifically divided into the data sets, the question-answer text pairs corresponding to the same piece of answer text can be divided into the same data set based on the pieces of answer text corresponding to the question-answer text pairs.

Further, for each data set, the using frequencies of different pieces of reply text in each data set can be counted respectively. Then, the piece of reply text with the highest using frequency is determined based on the using frequencies of the pieces of reply text in each data set, and the piece of reply text is combined with the predetermined question and answer text corresponding to the question-answer text pairs in the data set, to obtain a set of training data.

Specifically, for example, for a certain data set, the data set includes 10 question-answer text pairs, where the previously described 10 question-answer text pairs correspond to predetermined question P and answer text Q. It is further determined, by counting, that the reply text in six question-answer text pairs in the data set uses content a in answer text Q, the reply text in three question-answer text pairs uses content b in answer text Q, and the reply text in one question-answer text pair uses content c in answer text Q. Next, reply text a with the highest using frequency, corresponding answer text Q, and predetermined question P are further determined as a set of training data.

Multiple sets of training data can be constructed for the multiple data sets based on the previously described method. Further, model training can be performed by using the previously described multiple sets of training data to obtain the predetermined machine reading model.

In one or more embodiments, during specific implementation, the BERT-based model or the BiDAF model, etc. can be used as an initial model, and then the previously described initial model is trained by using the previously described training data to obtain a satisfactory predetermined machine reading model capable of recognizing a key text in a piece of answer text based on the input answer text and predetermined question.

S504. The key text in the piece of target answer text is labeled to obtain a piece of labeled target answer text.

In one or more embodiments, during specific implementation, a starting position and an ending position of the key text in the piece of target answer text can be labeled based on the determined key text, to obtain the piece of labeled target answer text.

S505. The piece of labeled target answer text is fed back to an end-user device, where the end-user device is configured to display the piece of target answer text to a user and identify the one or more key texts in the piece of displayed target answer text in a predetermined identification way.

In one or more embodiments, during specific implementation, after the piece of labeled target answer text is obtained, the method can further include: the piece of labeled target answer text is fed back to the end-user device, where the end-user device is configured to display the piece of target answer text to the user and identify the one or more key texts in the piece of displayed target answer text in the predetermined identification way.

Correspondingly, the end-user device can receive the previously described piece of labeled target answer text, display the piece of target answer text to the user based on the previously described piece of labeled target answer text, and in the piece of displayed target answer text, identify the one or more key texts in the piece of target answer text in the predetermined identification way.

The previously described predetermined identification way can specifically be understood as an identification way used to highlight the one or more key texts in the piece of target answer text.

In one or more embodiments, the predetermined identification way can include at least one of below: highlighting a character in the text, making the character in the text bold, underlining the character in the text, etc. Of course, it is worthwhile to note that the predetermined identification ways listed above are merely illustrative descriptions. During specific implementation, other appropriate identification ways can further be used as the previously described predetermined identification way based on specific applications, which are not limited in the present specification.

Specifically, the end-user device usually highlights characters in a key text “the delivery cost for one trip of a desktop computer is about 100, specifically subject to the actual logistics fees” in the piece of target answer text displayed to the user in the predetermined identification way, so that the previously described key text can be obviously distinguished from other text content in the piece of target answer text and attract the attention of the user. As such, the user can pay attention to and read the key text in the previously described piece of target answer text efficiently, and does not need to read the whole piece of target answer text as usual to identify key text content that the user needs.

In one or more embodiments, during specific implementation, the server can also extract the previously described key text from the piece of target answer text for direct feedback to the end-user device after the key text in the piece of target answer text is determined. As such, the end-user device can directly display the key text to the user.

In the present embodiments, the piece of answer text that corresponds to the target question in the predetermined knowledge base is determined as the piece of target answer text at first; then the key text that is associated with the target question and corresponds to a relatively high user attention measure is recognized and determined from the piece of target answer text, and the previously described key text in the piece of target answer text is labeled; and further, the previously described key text can be identified in the piece of target answer text displayed to the user. Therefore, the user can read relatively valuable key information that the user pays more attention to in the piece of target answer text conveniently and efficiently, and does not need to waste energy and time to read all content in the piece of target answer text to search for the key information that the user needs, and user experiences are improved.

In one or more embodiments, when the predetermined machine reading model is trained and constructed, to ensure that the trained predetermined machine reading model is better in coverage and can recognize the key text in the piece of target answer text more accurately and comprehensively, during specific implementation, after the piece of reply text with the highest using frequency in each data set and the predetermined question and answer text corresponding to the question-answer text pairs in the data set are obtained as the training data, the previously described training data can further be extended to extend a coverage of the training data used to train the predetermined machine reading model. Specifically, the following can be included: the predetermined question in the training data is extended to obtain multiple extended questions; and the training data is extended based on the extended questions.

In one or more embodiments, taking extending a piece of training data as an example, during specific implementation, multiple questions that are semantically the same as or similar to a predetermined question in the training data and can indicate the same piece of answer text are obtained as extended questions by semantic extension, etc. For example, for predetermined question P, multiple different extended questions capable of corresponding to answer text Q, such as P1, P2, and P3, can be obtained based on the previously described method.

Further, the previously described obtained extended questions can be combined with a piece of answer text (for example, Q) and a piece of reply text (for example, a) in the training data to obtain multiple sets of new training data, such as training data set 1 [P1, Q, a], training data set 2 [P2, Q, a], and training data set 3 [P3, Q, a], thereby achieving the extension of the training data.

The multiple sets of training data can be extended respectively based on the previously described method to obtain relatively richer training data with a wider coverage, and further, the predetermined machine reading model is subsequently trained by using the previously described extended training data so that the processing accuracy of the model can be improved, and a data range that the model is applicable to can be extended.

In one or more embodiments, references can be made to FIG. 6, during specific implementation, the previously described operation that one or more key texts in the piece of target answer text is determined can further include the following content: a predetermined cache is retrieved to determine a predetermined text matched with the piece of target answer text as the key text in the piece of target answer text, where the predetermined cache stores multiple predetermined texts, and the predetermined texts correspond to the answer text in the predetermined knowledge base respectively.

In one or more embodiments, the previously described predetermined text can specifically include a key text that is determined in advance and corresponds to the answer text stored in the predetermined knowledge base. The previously described cache can specifically be a relational database service (RDS) cache or a cache of another type.

In one or more embodiments, before specific implementation, the predetermined machine reading model can be called to process the answer text stored in the predetermined knowledge base respectively at first, to determine multiple key texts corresponding to the answer text stored in the predetermined knowledge base respectively for storage in the predetermined cache as the predetermined texts. The predetermined cache can further store a mapping relationship between a predetermined text and a piece of answer text.

During specific implementation, when the server determines a present target question of the user and a piece of target answer text, the piece of target answer text does not need to be temporarily recognized to determine a key text, and instead, the predetermined cache can be retrieved based on the piece of target answer text to identify a predetermined text that is matched with the piece of target answer text and determined in advance. Further, the key text in the piece of target answer text can be labeled based on the predetermined text to obtain a piece of labeled target answer text for feedback to the end-user device. As such, the piece of labeled target answer text can be obtained more efficiently, time taken by the user for waiting can be shortened effectively, and the user experiences can further be improved.

In one or more embodiments, the predetermined text in the previously described predetermined cache can specifically be obtained based on the following method: the predetermined machine reading model is called to process based on a piece of answer text stored in the predetermined knowledge base and a predetermined question corresponding to the piece of answer text, to determine a key text in the piece of answer text as a predetermined text corresponding to the piece of answer text.

In one or more embodiments, considering that the predetermined knowledge base includes a relatively large amount of answer text and involves more data processing, when determining the predetermined text corresponding to the answer text in the predetermined knowledge base, the server can run the previously described predetermined machine reading model through a cloud computing platform (for example, open data processing service (ODPS)) to process the answer text stored in the predetermined knowledge base respectively, to obtain the multiple corresponding predetermined texts and store the previously described multiple predetermined texts in a predetermined database or data list (for example, a MySQL table). Then, the previously described predetermined texts stored in the predetermined database or data list are synchronized to the predetermined cache.

In one or more embodiments, further considering that some pieces of answer text have relatively short text content. For example, when a certain piece of answer text includes only one sentence, and the sentence is a key text. To reduce data processing and improve the processing efficiency, during specific implementation, before the predetermined machine reading model is called to process based on the answer text stored in the predetermined knowledge base and the predetermined question corresponding to the answer text, the method can further include: whether a content length of each piece of answer text stored in the predetermined knowledge base is greater than a predetermined length threshold (for example, 80 characters) is detected; and the predetermined machine reading model is called to recognize a piece of answer text (which can be recorded as a long text for short) with a content length greater than the predetermined length threshold and a predetermined question corresponding to the long text, to determine a corresponding predetermined text for storage in the predetermined cache.

For a piece of answer text (which can be recorded as a short text for short) with a content length less than or equal to the predetermined length threshold in the predetermined knowledge base, the server wastes no more processing resources or processing time to determine a key text of the previously described short text. Correspondingly, the server can directly feed back the previously described short text to the end-user device without any processing. Therefore, the overall processing efficiency can further be improved.

In one or more embodiments, further considering that the answer text stored in the predetermined knowledge base may be updated. For example, when a piece of original answer text stored in the predetermined knowledge base for an original predetermined question is modified or there is a new piece of answer text for a new predetermined question in the predetermined knowledge base. An error is prone to be caused if the key text in the piece of target answer text is still determined and labeled based on the original predetermined cache.

Therefore, during specific implementation, the following content can further be included: whether the answer text in the predetermined knowledge base is updated is detected; and the predetermined text stored in the predetermined cache is updated by using the predetermined machine reading model after the answer text in the predetermined knowledge base is updated.

In one or more embodiments, during specific implementation, the previously described operation that the predetermined text stored in the predetermined cache is updated by using the predetermined machine reading model can include: a piece of new answer text in the predetermined knowledge base and a new predetermined question are processed by using the predetermined machine reading model to determine a new key text as a new predetermined text for storage in the predetermined cache. The following can further be included: a piece of modified answer text in the predetermined knowledge base and an original predetermined question corresponding to the piece of answer text are processed by using the predetermined machine reading model to determine a modified key text, and an original predetermined text in the predetermined cache is replaced with the previously described modified key text, etc. Therefore, the predetermined texts stored in the predetermined cache can be updated timely based on updating of the predetermined knowledge base.

In one or more embodiments, to determine the key text in the piece of target answer text more accurately and further reduce errors, during specific implementation, a first time tag can further be set for the predetermined text in the predetermined cache, and a second time tag can further be set for the answer text in the predetermined knowledge base.

The first time tag can specifically be used to indicate latest updating time of the predetermined text in the predetermined cache. The second time tag can specifically be used to indicate latest updating time of the answer text in the predetermined knowledge base.

In one or more embodiments, during specific implementation, after the predetermined cache is retrieved to determine the predetermined text matched with the piece of target answer text as the key text in the piece of target answer text, the method can further include the following content: whether the predetermined text is valid is determined based on the first time tag and the second time tag; and the predetermined machine reading model is called to determine the key text in the piece of target answer text based on the piece of target answer text and the target question after the predetermined text is determined to be invalid.

In one or more embodiments, it can be determined that the target answer text in the predetermined knowledge base is updated after updating time indicated by the second time tag is determined to be later than updating time indicated by the first time tag, while the corresponding predetermined text in the predetermined cache is not synchronously updated. As such, the present identified predetermined text can be determined to be invalid, namely the predetermined text presently stored in the predetermined cache is not necessarily the key text of the piece of target answer text. As such, the server can call the predetermined machine reading model to process based on the piece of target answer text and the target question to re-determine the key text in the piece of target answer text. Further, the corresponding predetermined text in the predetermined cache can be replaced with the re-determined key text to update the predetermined cache.

In one or more embodiments, considering that, in some scenarios, the server may store the updated predetermined text in the predetermined database or data list at first and then update the predetermined text in the predetermined cache through the predetermined database or data list, the predetermined database or data list can further be retrieved after the predetermined text is determined to be invalid based on the previously described method, to search for a predetermined text updated later than the piece of target answer text as a valid predetermined text. The key text in the piece of target answer text can be determined based on the previously described valid predetermined text after the previously described valid predetermined text is identified, and the predetermined cache is updated based on the previously described key text.

In one or more embodiments, it can be determined that the predetermined text in the predetermined cache is synchronously updated with the piece of target answer text in the predetermined knowledge base after the updating time indicated by the second time tag is determined to be earlier than the updating time indicated by the first time tag. As such, the presently identified predetermined text can be determined to be valid. As such, the previously described predetermined text is determined as the key text in the piece of target answer text.

In one or more embodiments, the previously described predetermined text can further be determined in another way independent of the predetermined machine reading model.

Specifically, the previously described predetermined text can be determined based on the following method: a historical customer service reply record is obtained; a question-answer text pair is extracted from the historical customer service reply record, where the question-answer text pair includes a question text asked by a user and a piece of reply text returned by a customer service agent, and the piece of reply text includes a part of text data extracted by the customer service agent for use from a piece of answer text; the piece of answer text corresponding to the piece of reply text in the question-answer text pair and a predetermined question corresponding to the question text in the question text are determined based on the predetermined knowledge base, namely the piece of answer text and predetermined question corresponding to the question-answer text pair are determined based on the predetermined knowledge base; a using frequency of each piece of reply text is counted; and the piece of reply text that corresponds to the same piece of answer text and has the highest using frequency is determined as a predetermined text corresponding to the piece of answer text.

It can be seen from above, according to the answer text processing method provided in the embodiments of the present specification, a piece of answer text that corresponds to a target question is determined from a predetermined knowledge base as a piece of target answer text at first; then one or more key texts that are associated with the target question and correspond to a relatively high user attention measure are recognized and determined from the piece of target answer text, and the previously described key text in the piece of target answer text is labeled; and further, the previously described key text can be automatically recognized and identified in the piece of target answer text displayed to a user. Therefore, the user can directly read relatively valuable key information that the user pays more attentions to in the piece of target answer text conveniently and efficiently without wasting energy and time to read all content in the piece of target answer text, and user experiences are improved. In addition, key texts corresponding to answer text stored in the predetermined knowledge base respectively are determined as predetermined texts at first by using a predetermined machine reading model, and the previously described predetermined texts are synchronously stored in a predetermined cache; and no more time and resources are wasted to temporarily re-determine a corresponding key text after a question asked by the user is obtained, instead, the corresponding predetermined text can be identified from the existing predetermined texts stored in the predetermined cache as the key text, so that the data processing efficiency can be improved, time taken by the user for waiting can be reduced, and the user experiences can further be improved.

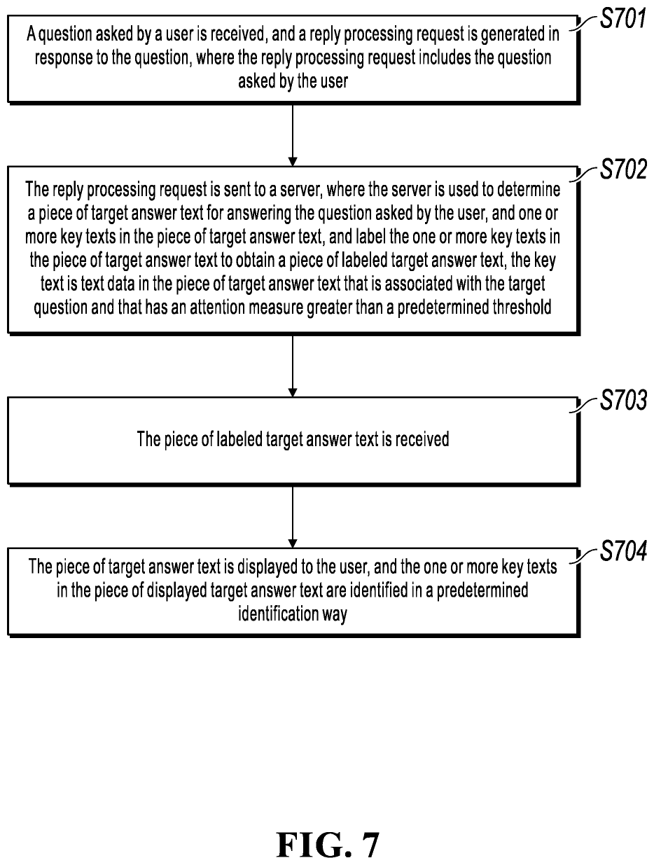

References can be made to FIG. 7, and the embodiments of the present specification further provide an answer text processing method. During specific implementation, the method can include the following content.

S701. A question asked by a user is received, and a reply processing request is generated in response to the question, where the reply processing request includes the question asked by the user.

S702. The reply processing request is sent to a server, where the server is used to determine a piece of target answer text for answering the question asked by the user and one or more key texts in the piece of target answer text and label the one or more key texts in the piece of target answer text to obtain a piece of labeled target answer text, and the key text is text data in the piece of target answer text that is associated with a target question and corresponds to an attention measure greater than a predetermined threshold.

S703. The piece of labeled target answer text is received.

S704. The piece of target answer text is displayed to the user, and the key text in the piece of displayed target answer text is identified in a predetermined identification way.

In one or more embodiments, the previously described answer text processing method can specifically be applied to an end-user device, where the end-user device is on a user side. The user can ask the question through the previously described end-user device.

In one or more embodiments, the user can ask the question in a customer service group through the previously described end-user device, or can ask the question in a dialog box with a customer service robot, an after-sales service robot, or a seller, or can further enter the question to be asked at a question feedback interface in a related APP.

In one or more embodiments, the predetermined identification way can specifically include at least one of below: highlighting a character in the text, making the character in the text bold, underlining the character in the text, etc.

In one or more embodiments, the end-user device can further detect whether the user activates an identification instruction after receiving the piece of labeled target answer text. The piece of target answer text can be displayed to the user after it is detected that the user activates the identification instruction, and the key text in the piece of displayed target answer text is identified in the predetermined identification way. The piece of target answer text can be directly displayed to the user after it is detected that the user does not activate the identification instruction. Therefore, diversified needs of the user can be met, and user experiences can further be improved.

It can be seen from above, according to the answer text processing method provided in the embodiments of the present specification, a key text in a piece of target answer text displayed to a user can be automatically recognized and identified, so that the user can directly read relatively valuable key information that the user pays more attentions to in the piece of target answer text conveniently and efficiently without wasting energy and time to read all contents in the piece of target answer text, and the user experiences are improved.

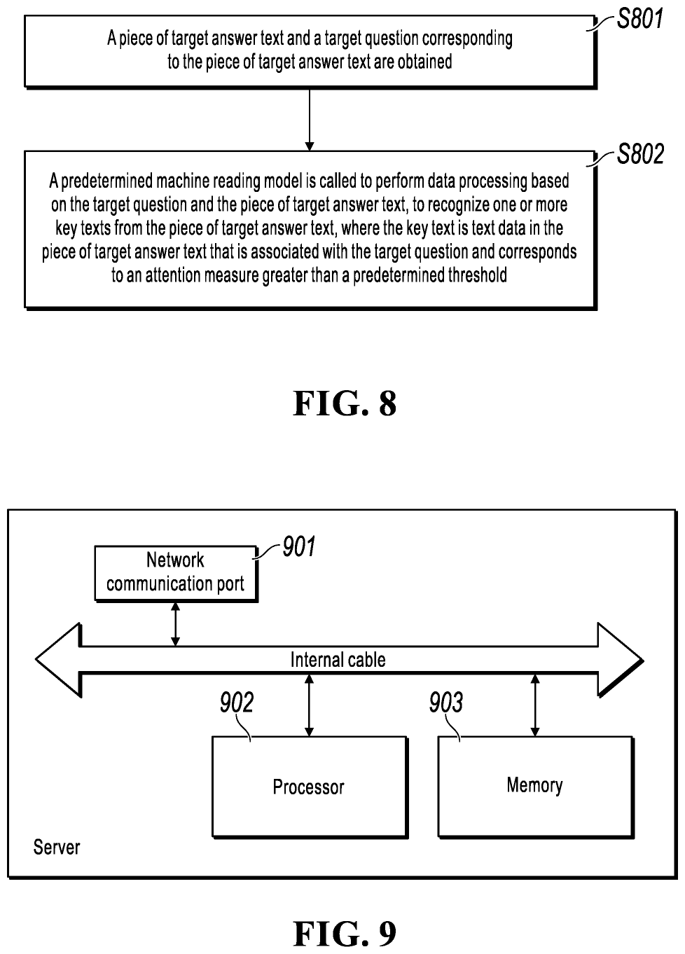

The embodiments of the present specification further provide a key text determination method. References can be made to FIG. 8, and during specific implementation, the method can include the following content.

S801. A piece of target answer text and a target question corresponding to the piece of target answer text are obtained.

S802. A predetermined machine reading model is called to perform data processing based on the target question and the piece of target answer text, to recognize one or more key texts from the piece of target answer text, where the key text is text data in the piece of target answer text that is associated with the target question and corresponds to an attention measure greater than a predetermined threshold.

In one or more embodiments, the previously described predetermined machine reading model can specifically be understood as a pre-trained data processing model capable of recognizing and determining key texts from answer text based on the answer text and corresponding questions.

In one or more embodiments, the predetermined machine reading model can specifically be constructed based on the following method: a historical customer service reply record is obtained; a question-answer text pair is extracted from the historical customer service reply record, where the question-answer text pair includes a question text asked by a user and a piece of reply text returned by a customer service agent, and the piece of reply text includes a part of text data extracted by the customer service agent for use from a piece of answer text; a piece of answer text corresponding to the piece of reply text in the question-answer text pair and a predetermined question corresponding to the question text in the question text are determined based on a predetermined knowledge base, namely the piece of answer text and predetermined question corresponding to the question-answer text pair are determined based on the predetermined knowledge base; training data is constructed based on the question-answer text pair, the corresponding piece of answer text and the corresponding predetermined question, the training data is constructed based on the question-answer text pair and the piece of answer text and predetermined question corresponding to the question-answer text pair, where each set of training data in the training data at least includes a predetermined question, a piece of reply text, and a piece of answer text; and model training is performed by using the training data to obtain the predetermined machine reading model.

In one or more embodiments, the previously described method can further be extended to recognition and determination of a key text in a long text in another application. For example, the method can further be applied to recognition and determination of a key text in a contract text, or recognition and determination of a key text in a mail text, etc., which are not limited in the present specification.

The embodiments of the present specification further provide a server, including a processor and a memory configured to store an instruction executable by the processor. During specific implementation, the processor can perform the following steps based on the instruction: determining a target question; determining a piece of answer text that corresponds to the target question from a predetermined knowledge base as a piece of target answer text, where the predetermined knowledge base stores multiple pieces of answer text; determining one or more key texts in the piece of target answer text, where the key text is text data in the piece of target answer text that is associated with the target question and corresponds to an attention measure greater than a predetermined threshold; and labeling the one or more key texts in the piece of target answer text to obtain a piece of labeled target answer text.

To execute the previously described instruction more accurately, references can be made to FIG. 9, and the embodiments of the present specification further provide another specific server. The server includes a network communication port 901, a processor 902, and a memory 903. The previously described structures are connected through an internal cable, so that each structure can implement specific data interaction.

The network communication port 901 can specifically be configured to obtain a question asked by a user.

The processor 902 can specifically be configured to determine a matched predetermined question from multiple predetermined questions as a target question based on the question asked by the user, determine a piece of answer text that corresponds to the target question from a predetermined knowledge base as a piece of target answer text, the predetermined knowledge base storing multiple pieces of answer text, determine one or more key texts in the piece of target answer text, the key text is text data in the piece of target answer text that is associated with the target question and corresponds to an attention measure greater than a predetermined threshold, and label the one or more key texts in the piece of target answer text to obtain a piece of labeled target answer text.

The memory 903 can specifically be configured to store a corresponding instruction program.

In the present embodiment, the network communication port 901 can be different virtual ports bound with different communication protocols to send or receive different data. For example, the network communication port can be a port responsible for web data communication, or a port responsible for file transfer protocol (FTP) data communication, or a port responsible for mail data communication. In addition, the network communication port can further be a physical communication interface or communication chip. For example, the network communication port can be a communication chip for a wireless mobile network such as global system for mobile communications (GSM) and code division multiple access (CDMA), or a wireless fidelity (Wifi) chip, or a Bluetooth chip.

In the present embodiments, the processor 902 can be implemented based on any appropriate method. For example, the processor can use forms of a microprocessor or processor and a computer-readable medium storing a computer-readable program code (such as software or firmware) executable by the microprocessor or processor, a logic gate, a switch, an application specific integrated circuit (ASIC), a programmable logic controller and an embedded microcontroller, etc., which are not limited in the present specification.

In the present embodiments, the memory 903 can include multiple layers. In a digital system, any device capable of storing binary data can be a memory. In an integrated circuit, a non-physical circuit with a storage function is also called a memory, such as a random access memory (RAM) and first in first out (FIFO). In a system, a physical storage device is also called a memory, such as a memory bank and a T-flash (TF) card.

The embodiments of the present specification further provide an end-user device, including a processor and a memory configured to store an instruction executable by the processor. During specific implementation, the processor can execute the following steps based on the instruction: receiving a question asked by a user, and generating a reply processing request in response to the question, where the reply processing request includes the question asked by the user; sending the reply processing request to a server, where the server is used to determine a piece of target answer text for answering the question asked by the user and one or more key texts in the piece of target answer text, and label the one or more key texts in the piece of target answer text to obtain a piece of labeled target answer text, and the key text is text data in the piece of target answer text that is associated with the target question and corresponds to an attention measure greater than a predetermined threshold; receiving the piece of labeled target answer text; and displaying the piece of target answer text to the user, and identifying the one or more key texts in the piece of displayed target answer text in a predetermined identification way.

The embodiments of the present specification further provide a computer storage medium based on the previously described answer text processing method. The computer storage medium stores a computer program instruction. The computer program instruction is executed to implement the following operations: determining a target question; determining a piece of answer text that corresponds to the target question from a predetermined knowledge base as a piece of target answer text, where the predetermined knowledge base stores multiple pieces of answer text; determining one or more key texts in the piece of target answer text, where the key text is text data in the piece of target answer text that is associated with the target question and corresponds to an attention measure greater than a predetermined threshold; and labeling the one or more key texts in the piece of target answer text to obtain a piece of labeled target answer text.

In the present embodiments, the previously described storage medium includes, but is not limited to, a RAM, a read-only memory (ROM), a cache, an HDD, or a memory card. The memory can be configured to store the computer program instruction. A network communication unit can be an interface disposed based on a standard specified in a communication protocol and configured to perform network connection communication.

In the present embodiments, functions and effects specifically achieved by the program instruction stored in the computer storage medium can be explained with reference to other implementations, and details are omitted here for simplicity.

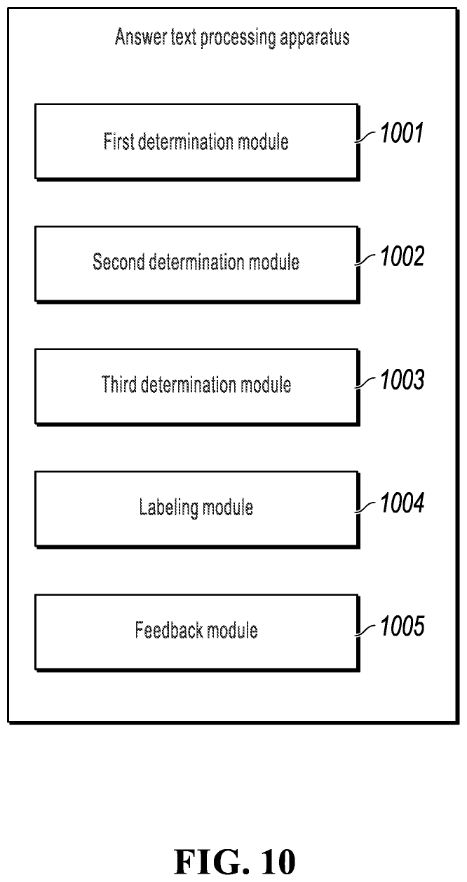

References can be made to FIG. 10, on a software level, the embodiments of the present specification further provide an answer text processing apparatus. The apparatus can specifically include the following structural modules: a first determination module 1001, specifically configured to determine a target question; a second determination module 1002, specifically configured to determine a piece of answer text that corresponds to the target question from a predetermined knowledge base as a piece of target answer text, where the predetermined knowledge base stores multiple pieces of answer text; a third determination module 1003, specifically configured to determine one or more key texts in the piece of target answer text, where the key text is text data in the piece of target answer text that is associated with the target question and corresponds to an attention measure greater than a predetermined threshold; a labeling module 1004, specifically configured to label the key text in the piece of target answer text to obtain a piece of labeled target answer text; and a feedback module 1005, specifically configured to feed back the piece of labeled target answer text to an end-user device, where the end-user device is configured to display the piece of target answer text to a user and identify the one or more key texts in the piece of displayed target answer text in a predetermined identification way.

It is worthwhile to note that the unit, apparatus, or module, etc. illustrated in the previously described embodiments can be implemented by using a computer chip or an entity, or can be implemented by using a product having a certain function. For convenient description, the previously described apparatus is functionally divided into various modules for respective description. Of course, when the present specification is implemented, functions of each module can be implemented in one or more pieces of software and/or hardware, or the module implementing the same function can be implemented by a combination of multiple submodules or subunits. The apparatus embodiments described above are merely illustrative. For example, division of the units is only a logical function division, and other division methods can be used during practical implementation. For example, multiple units or components can be combined or integrated into another system, or some characteristics can be ignored or not executed. In addition, coupling or direct coupling or communication connection between the displayed or discussed components can be indirect coupling or communication connection, implemented through some interfaces, of the apparatus or the units, and can be electrical and mechanical or use other forms.

The embodiments of the present specification further provide another answer text processing apparatus, including the following structural modules: a first receiving module, specifically configured to receive a question asked by a user and generate a reply processing request in response to the question, where the reply processing request includes the question asked by the user; a sending module, specifically configured to send the reply processing request to a server, where the server is used to determine a piece of target answer text for answering the question asked by the user and one or more key texts in the piece of target answer text and label the key text in the piece of target answer text to obtain a piece of labeled target answer text, and the key text is text data in the piece of target answer text that is associated with a target question and corresponds to an attention measure greater than a predetermined threshold; a second receiving module, specifically configured to receive the piece of labeled target answer text; and a display module, specifically configured to display the piece of target answer text to the user and identify the key text in the piece of displayed target answer text in a predetermined identification way.

It can be seen from above, according to the answer text processing apparatuses provided in the embodiments of the present specification, a key text in a piece of target answer text displayed to a user can be automatically determined and identified, so that the user can directly read relatively valuable key information that the user pays more attentions to in the piece of target answer text conveniently and efficiently without wasting energy and time to read all content in the piece of target answer text, and user experiences are improved.

Although the present specification provides the operation steps of the methods as described in the embodiments or flowcharts, more or fewer operation steps can be included based on conventional or non-inventive means. The step sequence listed in the embodiments is only an example, and does not represent there is only one execution sequence. When actual apparatuses or client products are executed, they can be executed sequentially or in parallel based on the method shown in the embodiments or the drawings (for example, in a parallel processor or multi-thread processing environment, or even in a distributed data processing environment). The term “include,” “comprise,” or their any other variant is intended to cover a non-exclusive inclusion, so that a process, method, product, or device that includes a series of elements not only includes those elements but also includes other elements that are not expressly listed, or further includes elements inherent to such process, method, product, or device. Without more constraints, the presence of additional identical or equivalent elements in the process, method, product, or device that includes the element is not precluded. The words such as “first” and “second” are used to indicate names, but do not indicate any particular order.

A person skilled in the art also knows that, in addition to implementing a controller by using computer-readable program code, the method steps can be logically programmed, so that the controller implements the same functions in the form of a logic gate, a switch, an application-specific integrated circuit, a programmable logic controller, an embedded microcontroller, etc. Therefore, the controller can be regarded as a hardware component, and an apparatus included therein for implementing various functions can also be regarded as the structure within the hardware component. Or even, the apparatus for implementing various functions can be regarded as both a software module for implementing a method and the structure within the hardware component.

The present specification can be described in a general context of a computer-executable instruction executed by a computer, for example, a program module. Generally, the program module includes routines, programs, objects, components, data structures, classes, etc. that perform specific tasks or implement specific abstract data types. The present specification can also be practiced in distributed computing environments where tasks are performed by remote processing devices connected through a communication network. In the distributed computing environments, program modules can be located in local and remote computer storage media including storage devices.

Through the description of the above implementations, a person skilled in the art can clearly understand that the present specification can be implemented by using software and a necessary general hardware platform. Based on such an understanding, the technical solutions of the present specification essentially can be embodied in a form of a software product. The computer software product can be stored in a storage medium, such as an ROM/RAM, a magnetic disk, or an optical disc, and includes several instructions for instructing a computer device (which can be a personal computer (PC), a mobile device, a server, or a network device, etc.) to perform the methods described in the embodiments of the present specification, or in certain parts of the embodiments of the present specification.

The embodiments of the present specification are described in a progressive way. For same or similar parts of the embodiments, references can be made to the embodiments. Each embodiment focuses on a difference from other embodiments. The present specification can be used in many general-purpose or special-purpose computer system environments or configurations. Examples are a personal computer, a server computer, a handheld device or a portable device, a tablet device, a multiprocessor system, a microprocessor-based system, a set-top box, a programmable electronic device, a network PC, a minicomputer, a mainframe computer, a distributed computing environment including any of the above systems or devices, etc.

Although the present specification has been described with reference to embodiments, a person of ordinary skill in the art knows that there are many variations and changes to the present specification without departing from the spirit of the present specification, and the appended claims should include these variations and changes without departing from the spirit of the present specification.

What is claimed is:

1. A method for processing answer text, comprising:
determining a target question;
determining a piece of text that corresponds to a target answer to the target question from a predetermined knowledge base, wherein the predetermined knowledge base stores a plurality of pieces of text that correspond to a plurality of target answers;
determining one or more portions of key text in the piece of text that corresponds to the target answer, wherein the portions of key text are text data in the piece of text that are associated with the target question and correspond to an attention measure greater than a predetermined threshold;
labeling the key text in the piece of text to obtain a piece of labeled text; and
providing the piece of labeled text to an end-user device, wherein the end-user device is configured to display the piece labeled of text to a user and emphasize the one or more key text portions in the displayed piece of text.

2. The method according to claim 1, wherein emphasizing the one or more key text portions comprises at least one of: highlighting a character in the key text, making the character in the key text bold, or underlining the character in the key text.

3. The method according to claim 1, wherein the determining a target question comprises:
obtaining a question asked by the user; and
determining a matched predetermined question from multiple predetermined questions as the target question based on the question asked by the user.

4. The method according to claim 1, wherein determining one or more portions of key text in the piece of text comprises:
calling a predetermined machine reading model to perform data processing based on the target question and the piece of text;
determining, by the machine reading model, an attention measure for a plurality of portions of the piece of text; and
recognizing the one or more portions of key text from the piece of text corresponding to an attention measure greater than the predetermined threshold.

5. The method according to claim 4, wherein the predetermined machine reading model is constructed based by:
obtaining a historical customer service reply record;
extracting a question-answer text pair from the historical customer service reply record, wherein the question-answer text pair comprises a question text and a piece of reply text returned by a customer service agent, and the piece of reply text comprises a part of text data extracted by the customer service agent for use from a particular piece of text of the plurality of perceives of text;
determining the particular piece of text and a predetermined question corresponding to the question-answer text pair based on the predetermined knowledge base;
constructing training data based on the question-answer text pair, the particular piece of text, and the predetermined question corresponding to the question-answer text pair, wherein the training data comprises the predetermined question, the piece of reply text, and the particular piece of text; and
performing model training by using the training data to obtain the predetermined machine reading model.

6. The method according to claim 5, wherein constructing the training data based on the question-answer text pair and the piece of text and predetermined question corresponding to the question-answer text pair comprises:
dividing a plurality of question-answer text pairs into multiple data sets, wherein the piece of reply text in each question-answer text pair in a same data set comes from a same particular piece of text;
counting a frequency of use for each piece of reply text in each data set; and
obtaining the piece of reply text with a highest frequency of use in each data set and a particular predetermined question-and-answer text corresponding to the question-answer text pairs in the data set as training data.

7. The method according to claim 6, wherein after obtaining the piece of reply text with a highest frequency of use in each data set and the particular predetermined question-and-answer text corresponding to the question-answer text pairs in the data set as training data, the method further comprises:
extending the predetermined question in the training data to obtain multiple extended questions; and
extending the training data based on the extended questions.

8. The method according to claim 1, wherein determining one or more key texts in the piece of text further comprises:
retrieving a predetermined cache to determine a predetermined text matched with the piece of text as the key text in the piece of text, wherein the predetermined cache stores multiple predetermined texts, and the multiple predetermined texts correspond to the plurality of pieces of text that correspond to a plurality of target answers in the predetermined knowledge base respectively.

9. The method according to claim 8, wherein the predetermined text is obtained by:
calling a predetermined machine reading model to process the plurality of pieces of text stored in the predetermined knowledge base and a predetermined question corresponding to the piece of text to determine a key text from the piece of text.

10. The method according to claim 9, wherein the method further comprises:
detecting whether the plurality of pieces of text that correspond to a plurality of target answers in the predetermined knowledge base have been updated; and
in response to detecting that the plurality of pieces of text in the predetermined knowledge base have been updated, updating the predetermined text stored in the predetermined cache by using the predetermined machine reading model after the plurality of pieces of text in the predetermined knowledge base is updated.

11. The method according to claim 10, wherein a first time tag is set for the predetermined text in the predetermined cache, and a second time tag is set for the piece of text in the predetermined knowledge base.

12. The method according to claim 11, wherein after the retrieving a predetermined cache to determine a predetermined text matched with the piece of text as the key text in the piece of text, the method further comprises:
determining whether the predetermined text is valid based on the first time tag and the second time tag; and
in response to determining the predetermined text is invalid, calling the predetermined machine reading model to determine the key text in the piece of text based on the piece of text and the target question.

13. A non-transitory, computer-readable medium storing one or more instructions executable by a computer system to perform operations comprising:
determining a target question;
determining a piece of text that corresponds to a target answer to the target question from a predetermined knowledge base, wherein the predetermined knowledge base stores a plurality of pieces of text that correspond to a plurality of target answers;
determining one or more portions of key text in the piece of text that corresponds to the target answer, wherein the portions of key text are text data in the piece of text that are associated with the target question and correspond to an attention measure greater than a predetermined threshold;
labeling the key text in the piece of text to obtain a piece of labeled text; and
providing the piece of labeled text to an end-user device, wherein the end-user device is configured to display the piece labeled of text to a user and emphasize the one or more key text portions in the displayed piece of text.

14. The computer-readable medium of claim 13, wherein emphasizing the one or more key text portions comprises at least one of: highlighting a character in the key text, making the character in the key text bold, or underlining the character in the key text.

15. The computer-readable medium of claim 13, wherein the determining a target question comprises:
obtaining a question asked by the user; and
determining a matched predetermined question from multiple predetermined questions as the target question based on the question asked by the user.

16. The computer-readable medium of claim 13, wherein determining one or more portions of key text in the piece of text comprises:
calling a predetermined machine reading model to perform data processing based on the target question and the piece of text;
determining, by the machine reading model, an attention measure for a plurality of portions of the piece of text; and
recognizing the one or more portions of key text from the piece of text corresponding to an attention measure greater than the predetermined threshold.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining a target question;
determining a piece of text that corresponds to a target answer to the target question from a predetermined knowledge base, wherein the predetermined knowledge base stores a plurality of pieces of text that correspond to a plurality of target answers;
determining one or more portions of key text in the piece of text that corresponds to the target answer, wherein the portions of key text are text data in the piece of text that are associated with the target question and correspond to an attention measure greater than a predetermined threshold;
labeling the key text in the piece of text to obtain a piece of labeled text; and
providing the piece of labeled text to an end-user device, wherein the end-user device is configured to display the piece labeled of text to a user and emphasize the one or more key text portions in the displayed piece of text.

18. The system of claim 17, wherein emphasizing the one or more key text portions comprises at least one of: highlighting a character in the key text, making the character in the key text bold, or underlining the character in the key text.

19. The system of claim 17, wherein the determining a target question comprises:
obtaining a question asked by the user; and
determining a matched predetermined question from multiple predetermined questions as the target question based on the question asked by the user.

20. The system of claim 17, wherein determining one or more portions of key text in the piece of text comprises:
calling a predetermined machine reading model to perform data processing based on the target question and the piece of text;
determining, by the machine reading model, an attention measure for a plurality of portions of the piece of text; and
recognizing the one or more portions of key text from the piece of text corresponding to an attention measure greater than the predetermined threshold.
